(19) United States
(12) Patent Application Publication
(10) Pub. No.: US 2025/0116391 A1
(43) Pub. Date: Apr. 10, 2025

(54) METHOD FOR ADJUSTING LIGHT-EMITTING ANGLE OF INDUSTRIAL AND MINING LAMP WITHOUT LIGHT LOSS

(71) Applicant: Hengdian Group Tospo Lighting Co., Ltd., Jinhua (CN)

(72) Inventors: Jiangen WEI, Jinhua (CN); Meiling JIN, Jinhua (CN); Jinbiao CAI, Jinhua (CN); Yidong ZHANG, Jinhua (CN); Binqiang WU, Jinhua (CN)

(73) Assignee: Hengdian Group Tospo Lighting Co., Ltd., Jinhua (CN)

(21) Appl. No.: 18/912,468

(22) Filed: Oct. 10, 2024

(30) Foreign Application Priority Data
Oct. 10, 2023 (CN) 202311302491.0

(51) Int. Cl. F21V 14/08; F21V 9/14

(52) U.S. Cl. CPC F21V 14/08; F21V 9/14

(57) ABSTRACT

Disclosed is a method for adjusting a light-emitting angle of a high bay light without light loss, including the steps of: determining a light distribution of a light source; iteratively calculating a surface shape of a polarizing lens according to a change in a light-emitting angle of the light source, where the optical surface shape may reach a designed light-emitting angle according to theoretical calculation, and the light distribution is uniform; symmetrically mounting a plurality of polarizing lenses having the surface shape on the left and right above the light source; and adjusting the light-emitting angle by synchronously rotating the left-right symmetrical polarizing lenses.

### CROSS-REFERENCE TO RELATED APPLICATION

This Application claims priority to Chinese patent application No. 202311302491.0, filed Oct. 10, 2023, the entirety of which are herein incorporated by reference.

### TECHNICAL FIELD

The present disclosure belongs to the technical field of optical design of high bay light, and particularly relates to a method for adjusting a light-emitting angle of a high bay light without light loss.

### BACKGROUND

High bay lights are widely used in high-ceiling environments such as factories, large supermarkets, and warehouses. They are chosen by many consumers due to their professional lighting effects.

Currently, there are two common methods for adjusting a light-emitting angle of the whole high bay light. One method is to provide a reflector on the traditional glass light-emitting surface to reduce the light-emitting angle. However, this method fails to meet the latest requirements of glare treatment.

Another method is to discard the way of glass light emission and use a specially designed lens to deal with glare, and the light-emitting angle of the whole lamp is adjusted by changing the distance of the lens with respect to the LED. This method changes the optimal position of the LED in the lens design so that part of the light can only diffuse out of the lens by refraction, thus producing a certain light loss. The smaller the adjustment angle, the farther the lens is from the LED, and the greater the proportion of light loss.

### SUMMARY

In order to solve the problem set forth in the above background art, the present disclosure provides a method for adjusting a light-emitting angle of a high bay light without light loss, having the feature of the adjustment of the light-emitting angle without light loss.

In order to achieve the above-mentioned object, the present disclosure provides the following technical solution. A method for adjusting a light-emitting angle of a high bay light without light loss is provided, including the steps of:
(1), determining a light distribution of a light source;
(2), performing an iterative calculation according to a change in a light-emitting angle of the light source to obtain a surface shape of a polarizing lens;
(3), symmetrically mounting a plurality of polarizing lenses having the surface shape on the left and right above the light source; and
(4), adjusting the light-emitting angle by synchronously rotating the polarizing lenses symmetrical on the left and right.

Further, step (2) comprises performing a simultaneous calculation to obtain the surface shape of two polarizing lenses symmetrical on the left and right.

Further, step (2) includes:
(a), establishing a mapping relationship between the light source and a corresponding point of an illuminated surface according to a luminous flux conservation principle;
(b), calculating a coordinate value of a light-emitting surface of the lens; and
(c), calculating incident points of all emitted light rays, and connecting all of the incident points to construct a free curved surface shape of the polarizing lens.

Further, in step (a), the mapping relationship between the light source and the corresponding point of the illuminated surface is:

$${\int \int }_{Ω} I ( \vec{i} ) d Ω = {\int \int }_{D} E ( \vec{p} ) dA ,$$

where Ω is a range of a solid angle of the light source, E(\vec{p}) is an energy distribution at an illumination plane p, representing an angular distribution of a light intensity of the light source in a direction, D is a range of the illumination plane, dA is an area at point A, and I(\vec{i}) is a light intensity in a direction of an illumination point.

Further, step (b) comprises: setting the illuminated surface according to a fixed distance and angle; setting a distance between a target surface and the light source as h, setting a length and width of the target surface as a and b, setting a total luminous flux of the light source as φ, setting an illumination of the target surface as E, and setting a central light intensity as I0=φ/π; and dividing the illuminated surface into m and n equal parts in a step size K along an X direction and a Y direction, respectively.

Further, step (c) comprises solving a direction of the emitted light rays of the light source and points of the light rays illuminated on the illuminated surface according to the mapping relationship between the light source and the illuminated surface.

Further, step (c) comprises: determining a first incident point of a first incident light ray i to be incident on the lens, solving a first tangent plane at the first incident point according to conditions; determining a second incident point of a second incident light ray based on intersection of the second incident light ray with the first tangent plane; wherein when the light ray is refracted at the incident point, a refraction law relationship is satisfied: \sqrt{1+n²−2n(\vec{O}·\vec{I})}·\vec{N}=\vec{O}−n\vec{I}, wherein n is an index of refraction, \vec{O} is a unit vector of refracted light, \vec{I} is a unit vector of incident light, and \vec{N} is a normal vector to a tangent plane; solving a normal vector at a third incident point according to the refraction law relationship, and solving the incident points of all emitted light rays similarly.

Specifically, the polarizing lenses with an even number having the surface shape are symmetrically mounted on the left and right above the light source.

Compared with the prior art, the beneficial effects of the present disclosure are as follows:
1. In the present disclosure, the light-emitting angle is adjusted by synchronously rotating the polarizing lenses symmetrical on the left and right, and a relative distance between the polarizing lenses and the light source is unchanged during the adjustment so that the light-emitting efficiency may be ensured to be unchanged, thereby achieving the adjustment without light loss, and the glare meets the use requirements;
2. In the present disclosure, the optical surface shape of the polarizing lens may achieve a designed light-emitting angle through theoretical calculation while having an effect of uniform light distribution.

### BRIEF DESCRIPTION OF THE DRAWINGS

The accompanying drawings are used to provide further understanding of the present disclosure, constitute part of the description, are used together with the embodiments of the present disclosure to explain the present disclosure, and do not constitute a limitation of the present disclosure. In the drawings:

FIG. 1 is a schematic diagram of optical surface shapes of a polarizing lens according to the present disclosure;

FIG. 2 is an optical diagram at a light-emitting angle of 105 degrees according to the present disclosure;

FIG. 3 is an optical diagram at a light-emitting angle of 90 degrees according to the present disclosure;

FIG. 4 is an optical diagram at a light-emitting angle of 60 degrees according to the present disclosure;

FIG. 5 is a coordinate view of light source parameters according to the present disclosure;

FIG. 6 is a mesh diagram of an illuminated surface area according to the present disclosure; and

FIG. 7 is a schematic diagram of directions of emitted light rays of a light source and points of the light rays illuminated on an illuminated surface according to the present disclosure.

### DETAILED DESCRIPTION OF THE EMBODIMENTS

The technical solutions in the embodiments of the present disclosure will be clearly and completely described below in conjunction with the accompanying drawings in the embodiments of the present disclosure. Obviously, the described embodiments are only some embodiments of the present disclosure, not all embodiments. Based on the embodiments of the present disclosure, all other embodiments obtained by a person skilled in the art without inventive effort fall within the scope of the present disclosure.

### Embodiment 1

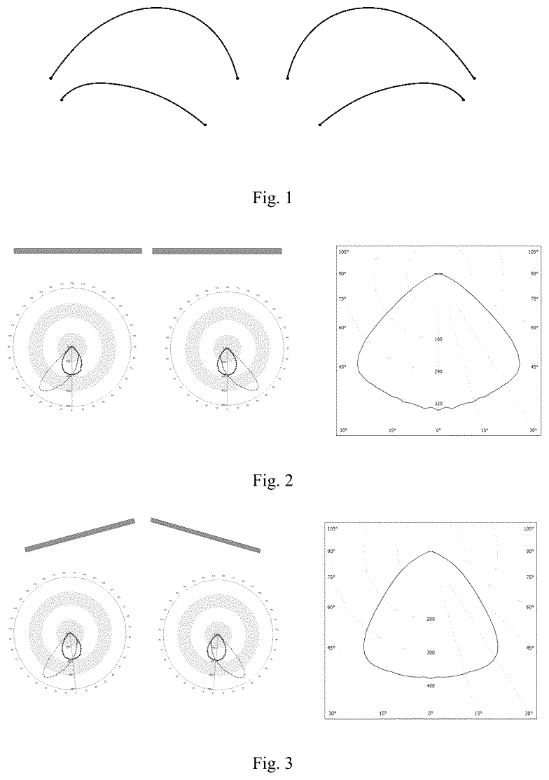

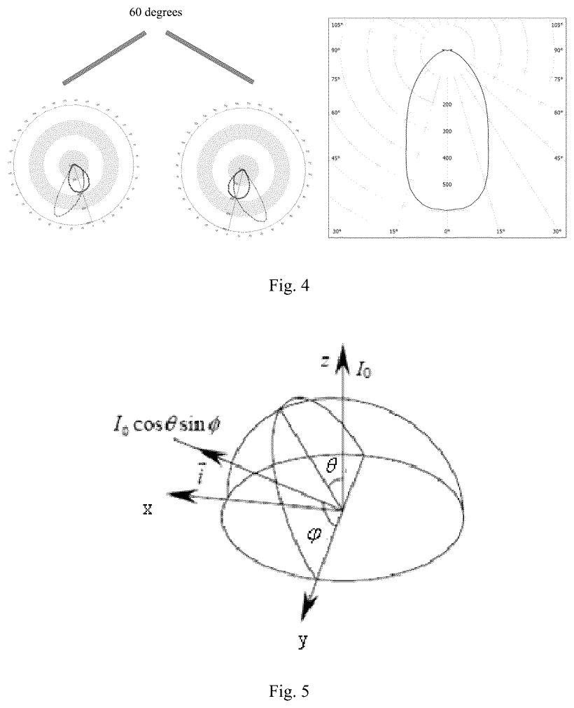

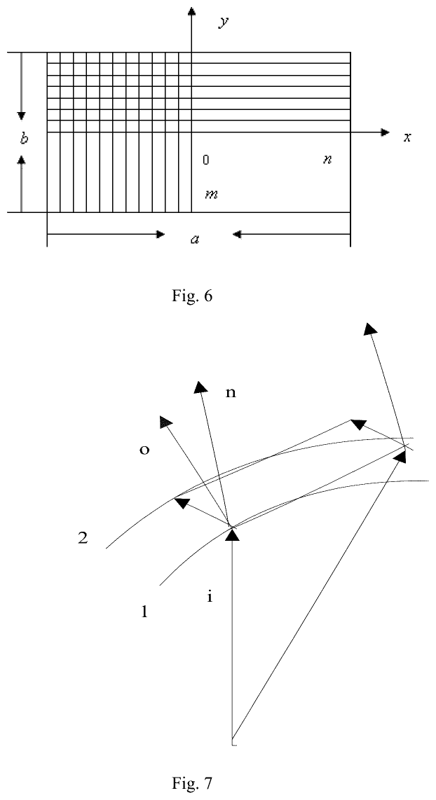

Referring to FIG. 1 to FIG. 7, the present disclosure provides the following technical solution. A method for adjusting a light-emitting angle of a high bay light without light loss is provided, including the steps of:
(1), determining a light distribution of a light source;
(2), performing an iterative calculation according to a change in a light-emitting angle of the light source to obtain a surface shape of a polarizing lens, where the optical surface shape may reach a designed light-emitting angle according to theoretical calculation, and the light distribution is uniform;
(3), symmetrical mounting two polarizing lenses having the surface shape on the left and right above the light source; and
(4), adjusting the light-emitting angle by synchronously rotating the polarizing lenses symmetrical on the left and right.

By adopting the above-mentioned technical solution, in the present disclosure, the light-emitting angle is adjusted by synchronously rotating the polarizing lenses symmetrical on the left and right, and a relative distance between each of the polarizing lenses and the light source is unchanged during the adjustment so that the light-emitting efficiency may be ensured to be unchanged, thereby achieving the adjustment without light loss, and the glare meets the use requirements.

Specifically, step (2) comprises performing a simultaneous calculation to obtain the surface shape of two polarizing lenses symmetrical on the left and right.

Specifically, step (2) includes:
(a), establishing a mapping relationship between the light source and a corresponding point of an illuminated surface according to a luminous flux conservation principle;
(b), calculating a coordinate value of a light-emitting surface of the lens; and
(c), calculating incident points of all emitted light rays, and connecting all of the incident points to construct a free curved surface shape of the polarizing lens.

Specifically, in step (a), the mapping relationship between the light source and the corresponding points of the illuminated surface is:

$${\int \int }_{Ω} I ( \vec{i} ) d Ω = {\int \int }_{D} E ( \vec{p} ) dA ,$$

where Ω is a range of a solid angle of the light source, E(\vec{p}) is an energy distribution at an illumination plane p, representing an angular distribution of a light intensity of the light source in a direction, D is a range of the illumination plane, dA is an area at point A, and I(\vec{i}) is a light intensity in a direction of an illumination point.

Specifically, in step (2), the illuminated surface is set according to a fixed distance and angle; a distance between a target surface and the light source is set as h, a length of the target surface is set as a, a width of the target surface is set as b, a total luminous flux of the light source is set as φ, an illumination of the target surface is set as E, and a central light intensity is set as I0=φ/π; and the illuminated surface is divided into m and n equal parts in a step size K along an X direction and a Y direction, respectively.

Specifically, in step (3), a direction of the emitted light rays of the light source and points of the light rays illuminated on the illuminated surface are solved according to the mapping relationship between the light source and the illuminated surface; assuming that a first incident point of a first incident light ray i to be incident on the lens is known, a first tangent plane at the first incident point is solved according to conditions; a second incident light ray intersects with the first tangent plane to determine a second incident point of the second incident light ray; since the light is refracted at the incident point, a refraction law relationship is satisfied:
\sqrt{1+n²−2n(\vec{O}·\vec{I})}·\vec{N}=\vec{O}−n\vec{I}, wherein n is an index of refraction, \vec{O} is a unit vector of refracted light, \vec{I} is a unit vector of incident light, and \vec{N} is a normal vector to a tangent plane. A normal vector at a third incident point is solved according to the refraction law relationship, and the incident points of all emitted light rays are solved in turn similarly.

### Embodiment 2

When the light-emitting angle is 105 degrees, the left and right polarizing lenses are in a horizontal state.

### Embodiment 3

When the light-emitting angle is 90 degrees, the left and right polarizing lenses are synchronously rotated downward by 7.5 degrees with respect to the horizontal state.

### Embodiment 4

When the light-emitting angle is 60 degrees, the left and right polarizing lenses are synchronously rotated downward by 22.5 degrees with respect to the horizontal state.

In summary, in the present disclosure, the light-emitting angle is adjusted by synchronously rotating the polarizing lenses symmetrical on the left and right, and a relative distance between each polarizing lens and the light source is unchanged during the adjustment so that the light-emitting efficiency may be ensured to be unchanged, thereby achieving the adjustment without light loss, and the glare meets the use requirements.

Finally, it should be noted that the above are only preferred embodiments of the present disclosure and are not intended to limit the present disclosure. Although the present disclosure has been described in detail with reference to the foregoing embodiments, it is still possible for a person skilled in the art to modify the technical solutions described in the foregoing embodiments or to make equivalent substitutions for some of the technical features therein. Therefore, any modifications, equivalent substitutions, improvements, etc. made within the spirits and principles of the present disclosure shall be included in the scope of the present disclosure.

1. A method for adjusting a light-emitting angle of a high bay light without light loss, comprising the steps of:
(1) determining a light distribution of a light source;
(2) performing an iterative calculation according to a change in a light-emitting angle of the light source to obtain a surface shape of a polarizing lens;
(3) symmetrically mounting a plurality of polarizing lenses having the surface shape on a left and right above the light source; and
(4) adjusting the light-emitting angle by synchronously rotating the polarizing lenses symmetrical on the left and right.

2. The method according to claim 1, wherein step (2) comprises:
performing a simultaneous calculation to obtain the surface shape of two polarizing lenses symmetrical on the left and right.

3. The method according to claim 1, wherein step (2) comprises:
(a) establishing a mapping relationship between the light source and a corresponding point of an illuminated surface according to a luminous flux conservation principle;
(b) calculating a coordinate value of a light-emitting surface of the lens; and
(c) calculating incident points of all emitted light rays, and connecting all of the incident points to construct a free curved surface shape of the polarizing lens.

4. The method according to claim 3, wherein, in step (a), the mapping relationship between the light source and the corresponding point of the illuminated surface is:
$${\int \int }_{Ω} I ( \vec{i} ) d Ω = {\int \int }_{D} E ( \vec{p} ) dA$$
wherein Ω is a range of a solid angle of the light source, E(\vec{p}) is an energy distribution at an illumination plane p, representing an angular distribution of a light intensity of the light source in a direction, D is a range of the illumination plane, dA is an area at point A, and I(\vec{i}) is a light intensity in a direction of an illumination point.

5. The method according to claim 3, wherein step (b) comprises:
setting the illuminated surface according to a fixed distance and angle, setting a distance between a target surface and the light source as h, setting a length and width of the target surface as a and b, setting a total luminous flux of the light source as φ, setting an illumination of the target surface as E, and setting a central light intensity as I0=φ/π; and
dividing the illuminated surface into m and n equal parts in a step size K along an X direction and a Y direction, respectively.

6. The method according to claim 3, wherein step (c) comprises:
solving a direction of the emitted light rays of the light source and points of the light rays illuminated on the illuminated surface according to the mapping relationship between the light source and the illuminated surface.

7. The method according to claim 6, wherein step (c) further comprises:
determining a first incident point of a first incident light ray i to be incident on the lens;
solving a first tangent plane at the first incident point according to conditions;
determining a second incident point of a second incident light ray based on intersection of the second incident light ray with the first tangent plane, wherein when the light ray is refracted at the incident point, a refraction law relationship is satisfied: \sqrt{1+n²−2n(\vec{O}·\vec{I})}·\vec{N}=\vec{O}−n\vec{I}, wherein n is an index of refraction, \vec{O} is a unit vector of refracted light, \vec{I} is a unit vector of incident light, and \vec{N} is a normal vector to a tangent plane;
solving a normal vector at a third incident point according to the refraction law relationship; and
solving the incident points of all emitted light rays similarly.

8. The method according to claim 1, wherein the polarizing lenses with an even number having the surface shape are symmetrically mounted on the left and right above the light source.
